(19) United States
(12) Patent Application Publication
(10) Pub. No.: US 2005/0166135 A1
(43) Pub. Date: Jul. 28, 2005

(54) Apparatus, system and method for synchronized playback of data transmitted over an asynchronous network

(76) Inventors: David G. Burke, West Valley City, UT (US); Timothy J. Gunn, Kerns, UT (US); Spencer Conley Kunzler, West Jordan, UT (US); Steven C. Lingwall, West Valley City, UT (US); Bryan C. Vanderwerff, Layton, UT (US); Clayton C. Wahlquist, West Valley City, UT (US)

Correspondence Address: KUNZLER & ASSOCIATES, 8 EAST BROADWAY, SALT LAKE CITY, UT, 84111, US

(21) Appl. No.: 11/029,327

(22) Filed: Jan. 5, 2005

Related U.S. Application Data
(60) Provisional application No. 60/534,232, filed on Jan. 5, 2004.

(51) Int. Cl. G06F 17/00; G06F 15/00

(52) U.S. Cl. 715/500.1; 370/503

(57) ABSTRACT

An apparatus, system and method for synchronizing the playback of data transmitted over an asynchronous network. An initialization module may initialize at least two receivers to receive playback data from a transmission module. The transmission module may then transmit to the receivers the playback data, and, in some embodiments, synchronization data. Synchronization data may include a playback indicator by which the receivers may determine an appropriate playback data consumption rate. A buffer module may buffer a predetermined amount of playback data which may be played in response to a start signal individually addressed to the receivers.

### CROSS-REFERENCES TO RELATED APPLICATIONS

This application claims the benefit of U.S. Provisional Patent Application No. 60/534,232 entitled “System, Method, and Apparatus for Synchronizing Playback of a Data Stream Over an Asynchronous Network” and filed on Jan. 5, 2004 for David Burke, Timothy Gunn, Conley Kunzler, Steve Lingwall, Bryan Vanderwerff, and Clayton Wahlquist.

### BACKGROUND OF THE INVENTION

1. Field of the Invention

This invention relates to apparatus, methods and systems for distributing data over an asynchronous network and more particularly relates to apparatus, methods and systems for synchronizing the playback of data distributed over an asynchronous network.

2. Description of the Related Art

In recent years, distribution line communications have evolved to enable a majority of homeowners and businesses to implement multimedia distribution systems once reserved for the wealthy. Conventional electrical power lines have now emerged as a powerful medium not only able to deliver electricity, but capable of distributing full duplex high-speed data and multimedia content.

The advantage of using electrical power lines as a data transmission medium is that the majority of buildings and homes are already equipped with power lines conveniently connecting each room to each other and to the power grid. Power line carrier (“PLC”) communications systems use existing AC electrical wiring as the network medium to provide high-speed network access points almost anywhere there is an AC outlet. Using the existing AC electrical wiring is easier than running new wires, more secure and more reliable than wireless systems, and relatively inexpensive.

Residential power line networks are particularly advantageous as they allow consumers to use their already existing electrical wiring systems to connect home appliances and other devices to each other and to the Internet. Home networks utilizing high-speed power line networking technology are able to control anything that plugs into an AC outlet, such as lights, television, thermostats, and alarms. Further, home power line networks are capable of distributing audio, video and other multimedia data throughout the home.

Despite their advantages, power line networks are prone to various obstacles inherent to power line technology. Traditional data and communications networks use dedicated wiring to interconnect devices. Power line networks, on the other hand, were never intended to communicate data signals and are instead optimized to distribute electrical power to outlets efficiently at frequencies between about 50 to 60 Hz. The physical characteristics of a power line, the appliances connected thereto, and the behavioral characteristics of the current itself combine to create obstacles to efficient power line data communications.

One such obstacle arises from interference and unpredictable noise from appliances such as halogen lamps, vacuum cleaners, blenders, hair dryers, and the like. Also, various characteristics of the power line are not controlled or constant over time. Such volatility may delay data transmission over the power line or cause lost packets that fail to reach the intended recipient.

Conventional power line networks have inherent data transmission delays due to the asynchronous nature of conventional power line networks. HomePlug™ 1.0 is an example of one power line networking standard. Other communications networks, such as ethernet and wireless communications that implement asynchronous communication protocols such as transmission control protocol/internet protocol (“TCP/IP”), also have data transmission delays that prevent simultaneous operation of two or more receivers of network data. Standards such as TCP/IP provide higher reliability that a recipient will receive network messages, but the cost is higher latency and data transmission delays.

Data transmission delays may be particularly obvious where receivers that are in close proximity to each other, such as in adjacent rooms within a home or building, attempt to receive identical multimedia content simultaneously. For example, when audio content is played back from multiple receivers, a delay of as little as fifteen milliseconds between receivers may be discerned by a listener. For video, loss or delay of fifteen to thirty frames may be noticeable to the user. Where two or more playback devices are simultaneously audible and/or visible, synchronous playback is imperative to a listener's media enjoyment.

Further, differences in timing clock precision in multiple receivers may cause even initially synchronous playback to drift apart over time. Moreover, data loss, an almost certain occurrence in power line communications, may exacerbate the problem by causing substantially delayed or accelerated playback at one location while another location maintains a fairly constant playback data consumption rate.

In conventional power line networks, if a single acknowledgment message is received in response to a broadcast message, the broadcasting device presumes that all devices on the power line network similarly received the broadcast message. Consequently, in conventional devices that initiate synchronous playback using a broadcast message, the broadcast device may not be aware that one or more playback devices failed to receive a playback initiation message or a general playback data message.

From the foregoing discussion, it should be apparent that a need exists for an apparatus, system, and method for the synchronized playback of data transmitted over an asynchronous network such as a power line network. Beneficially, such an apparatus, system and method would initially synchronize data playback between two or more receivers, maintain playback synchronization between receivers over time autonomously at each receiver, and compensate for data loss. Such apparatuses, systems, and methods are disclosed and claimed herein.

### SUMMARY OF THE INVENTION

The present invention has been developed in response to the present state of the art, and in particular, in response to the problems and needs in the art that have not yet been fully solved by currently available apparatus, systems and methods for synchronizing the playback of data transmitted over an asynchronous network. Accordingly, the present invention has been developed to provide an apparatus, system and method for synchronizing playback of data transmitted over an asynchronous network that overcomes many or all of the above-discussed shortcomings in the art.

An apparatus for synchronizing playback of data transmitted over an asynchronous network in accordance with certain embodiments of the present invention may include an initialization module, a transmission module, a receiver module, and a playback module. The initialization module may initialize at least two receivers to receive playback data from the transmission module. The transmission module may transmit the playback data to the receivers, and, in some embodiments, synchronization information and/or a playback indicator. The receiver module may receive the playback data and transmit such playback data to a buffer module. The buffer module may then buffer a predetermined amount of playback data received from the transmission module. The playback module may play the playback data in response to a start signal individually addressed to the receivers.

In embodiments where the transmission module transmits synchronization information to the receivers to maintain synchronization over time, the transmission module may intersperse a synchronization data packet between playback data packets transmitted over the asynchronous network. In other embodiments, the transmission module may periodically transmit a synchronization data packet at predetermined time intervals. In yet other embodiments, the transmission module may transmit synchronization data packets in response to user input.

In certain embodiments, the apparatus includes a determination module for determining, at the receivers, an appropriate playback data consumption rate based on the playback indicator. The playback indicator may include, for example, a play bit, a stop bit, or a playback time stamp. Where the playback indicator includes a play bit and/or stop bit, a consumption rate may be defined in relation to the time of receipt of such indicator. Alternatively, where the playback indicator is a playback time stamp, the playback data consumption rate may depend on correlation between the playback time stamp and a real-time clock of the receiver. In such embodiments, the initialization module may synchronize real-time clocks corresponding to the receivers with a reference clock to ensure synchronization between receivers.

In one embodiment, the apparatus further includes a detection module for detecting a difference in playback consumption rates between the receivers, and a compensation module for compensating for the difference in playback consumption rates. The compensation module may compensate for the difference in playback consumption rates by replacing missing playback data packets with pseudo data packets including, for example, previous playback data packets, predetermined data, or silence and/or one or more blank video frames of a suitable duration. Alternatively, the compensation module may adjust a speed of playback data consumption at the receiver.

A system is also presented for synchronizing the playback of data transmitted over an asynchronous network. A system in accordance with the present invention may be embodied by a transmitter, at least two receivers, a communication channel operatively connecting the transmitter to the receivers, and a playback device. The transmitter may be adapted to transmit playback data to the receivers over, in certain embodiments, a single communication channel integral to a power line network. The receivers may be adapted to receive the playback data from the transmitter and to coordinate playback from a playback device in response to a start signal individually addressed to the receivers.

The system, in one embodiment, may further include a determination module to determine an appropriate playback data consumption rate based on a playback indicator provided by the transmitter. The playback indicator may include a play bit, a stop bit, or a playback time stamp.

In certain embodiments, each of the receivers may include a detection module to detect a difference in data consumption rate of the receiver with respect to the data consumption rate indicated by the transmitter. The receivers may further include a compensation module to compensate for the difference in the playback data consumption rates and, in certain embodiments, to insert pseudo data to compensate for missing playback data.

A method of the present invention is also presented for synchronizing the playback of data transmitted over an asynchronous network. The method in the disclosed embodiments substantially includes the steps necessary to carry out the functions presented above with respect to the operation of the described apparatus and system.

The method, in some embodiments, may be embodied by a signal bearing medium tangibly embodying a program of machine-readable instructions executable by a digital processing apparatus to perform operations for synchronized playback over an asynchronous network. The signal bearing medium may include an operation to initialize at least two receivers, an operation to transmit over an asynchronous network playback data to the receivers, an operation to buffer a predetermined amount of playback data at the receivers, and an operation to play the playback data in response to a start signal individually addressed to each of the receivers.

In certain embodiments, the operations may include an operation to determine at each of the receivers a playback data consumption rate based on a playback indicator provided by a transmission module. As in the apparatus and system disclosed above, a playback indicator may include a playback bit or a playback time stamp.

In a further embodiment, the operations include an operation to detect a difference in a playback data consumption rate relative to a data consumption rate indicated at least in part by the playback indicator and an operation to compensate for the difference in playback data consumption rates. In some embodiments, an operation to compensate for the difference in playback data consumption rates may comprise replacing missing playback data packets with pseudo data packets including for example, previous playback data, predetermined data, or silence and/or blank video frames.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a cross-sectional view of a home equipped with one embodiment of a system for the synchronized playback of data transmitted over an asynchronous network in accordance with the present invention;

FIG. 2 is a block diagram of a system for synchronizing the playback of data transmitted over an asynchronous network in accordance with certain embodiments of the present invention;

FIG. 3 is a block diagram of an apparatus for synchronizing the playback of data transmitted over an asynchronous network in accordance with certain embodiments of the present invention.

FIG. 4 is a block diagram of an apparatus for the synchronized playback of data transmitted over an asynchronous network in accordance with certain embodiments of the present invention;

FIG. 5 is a block diagram of a playback data packet in accordance with certain embodiments of the present invention;

FIG. 6 is a block diagram of a synchronization packet in accordance with certain embodiments of the present invention;

FIG. 7 is a schematic flow chart diagram of one embodiment of playback logic in accordance with the present invention; and

FIG. 8 is a schematic flow chart diagram of one embodiment of a method for continuous synchronized playback of data transmitted over an asynchronous network in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are disclosed to provide a thorough understanding of embodiments of the present invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

As used in this specification, the term “asynchronous network” refers to a communications network where the timing of network message transmission and network message receipt is controlled by different timing clocks. One clock resides with the transmitter of a message and one clock resides with a receiver of a message, where each clock may or may not operate at the same frequency. In other words, the operation rate of the receiving clock is unrelated to the operation rate of the sending clock. A “synchronous network,” on the other hand, refers to a communications network where the timing of data transmission is determined by the source of the transmission, the transmitter. Consequently, identical messages sent to two or more receivers substantially simultaneously will arrive at the receivers substantially simultaneously. The term “synchronous” or “synchronized” as used herein refers to data transmissions or operations coinciding in time at more than one receiver. The term “playback” refers to the presentation of data from a data stream, the data comprising audio data, video data, other multimedia data, or any combination of the foregoing.

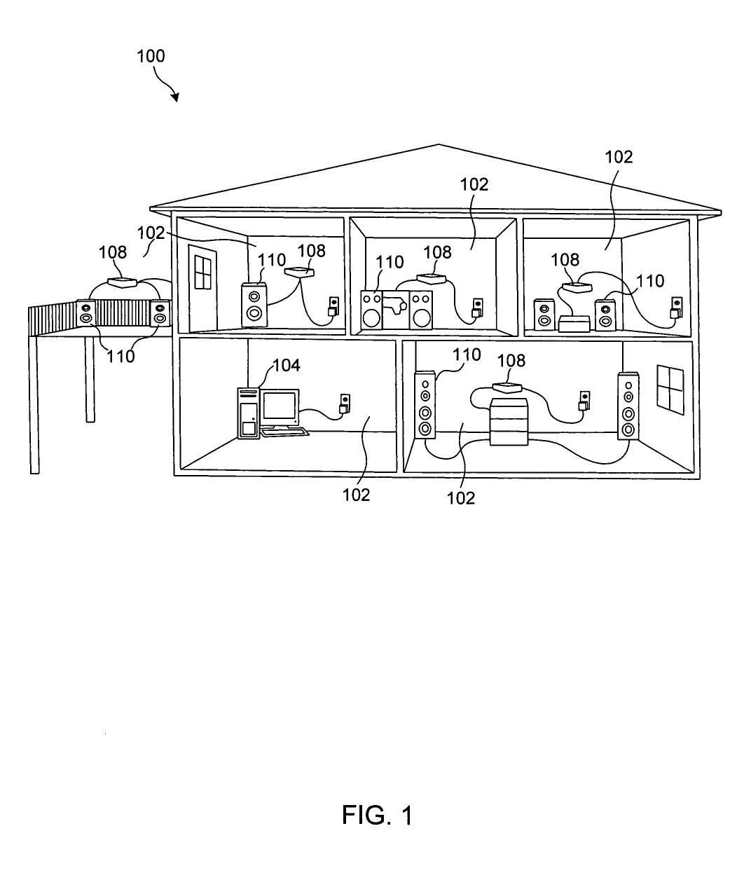

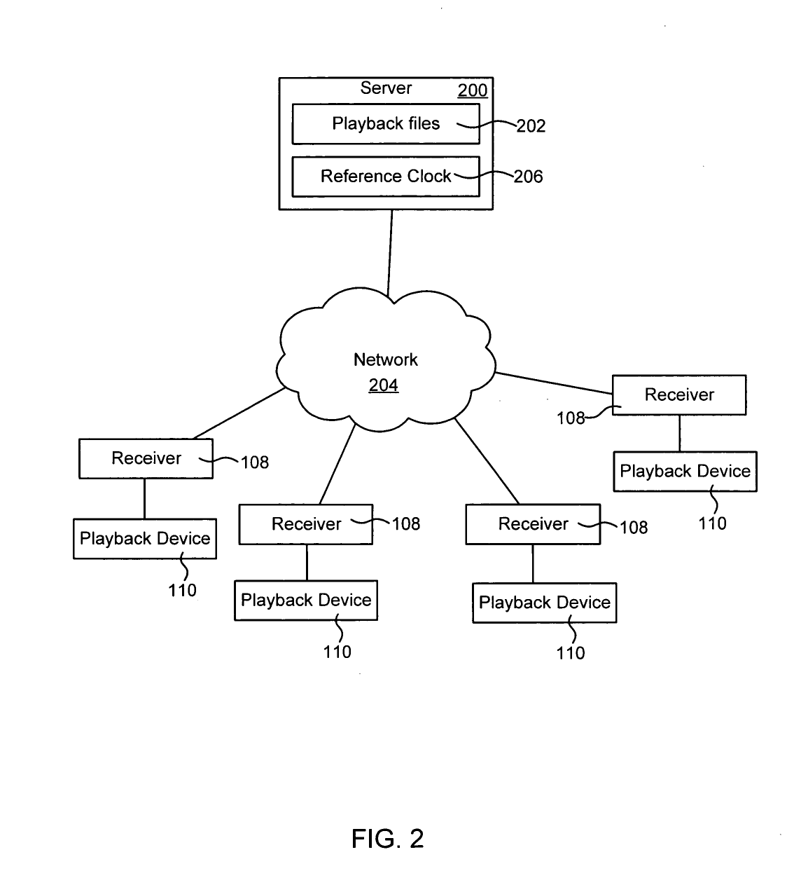

Referring now to FIGS. 1 and 2, a system for synchronized playback over an asynchronous network in accordance with the present invention may be implemented in a residential or commercial environment such as a home, office, or other building 100 having more than one discrete playback location 102. In a home environment, for example, two or more rooms may be equipped to receive and play playback data transmitted by a transmitter 104 over an asynchronous network.

In certain embodiments, a system in accordance with the present invention generally comprises a transmitter 104, at least two receivers 108, a power line network 204 (See FIG. 2) that connects the transmitter 104 to the receivers 108, and a playback device 110. A power line network 204 may support a communication channel for delivery of a short distance, high bandwidth signal using discrete communication packets. A communication channel may comprise a logical channel configured for synchronous playback of data provided by the transmitter 104 to one or more receivers 108. The communication channel may include various communications protocols and signal transmission mediums. Alternatively, any of various transmission mediums may be used to connect the transmitter 104 to the receivers 108 to implement the communication channel including, for example, coaxial cable, CAT 5 cable or wireless mediums. In FIG. 1, the power line network 204 may comprise the internal electrical wiring (not shown) of a building.

A transmitter 104 may compress data and/or modulate data onto a selected carrier frequency, or in certain embodiments, may transmit data over multiple carrier frequencies. A transmitter 104 may use any of various networking protocols to distribute data, such as any of various wired or wireless Ethernet protocols, asynchronous transfer mode (“ATM”), transmission control protocol internet protocol (“TCP/IP”), or any other protocol known to those in the art. A transmitter 104 may further encapsulate into packets data for transmission over an asynchronous network, and may add header information to each of the packets.

In certain embodiments, a transmitter 104 may comprise a central server 200 (See FIG. 2) storing data files 202. The server 200 may compress the data files 202 and/or encode the data files 202 into a format such as an MP3 format or other format known to those in the art, and may store data files 202 in compressed or uncompressed form. The server 200 may further format the files 202 into packets that can be sent over a network 204. The server 200 may send the data over the network 204, as bandwidth is available, to one or more destination receivers 108.

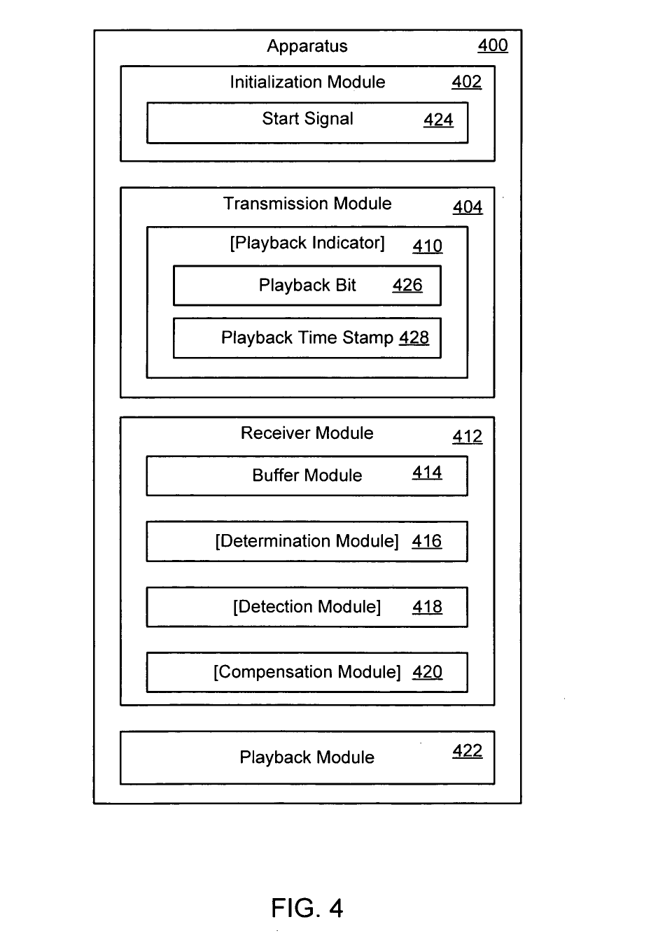

A transmitter 104 may further comprise a reference clock 206 that may be used to synchronize a clock of a receiver 108 with the transmitter 104 and, in certain embodiments, to synchronize a first receiver 108 with a second receiver 108, as discussed in more detail with reference to FIGS. 4-6 below. Alternatively, a reference clock 206 may comprise an independent time server, such as a time server located on a local area network (“LAN”) or on the Internet.

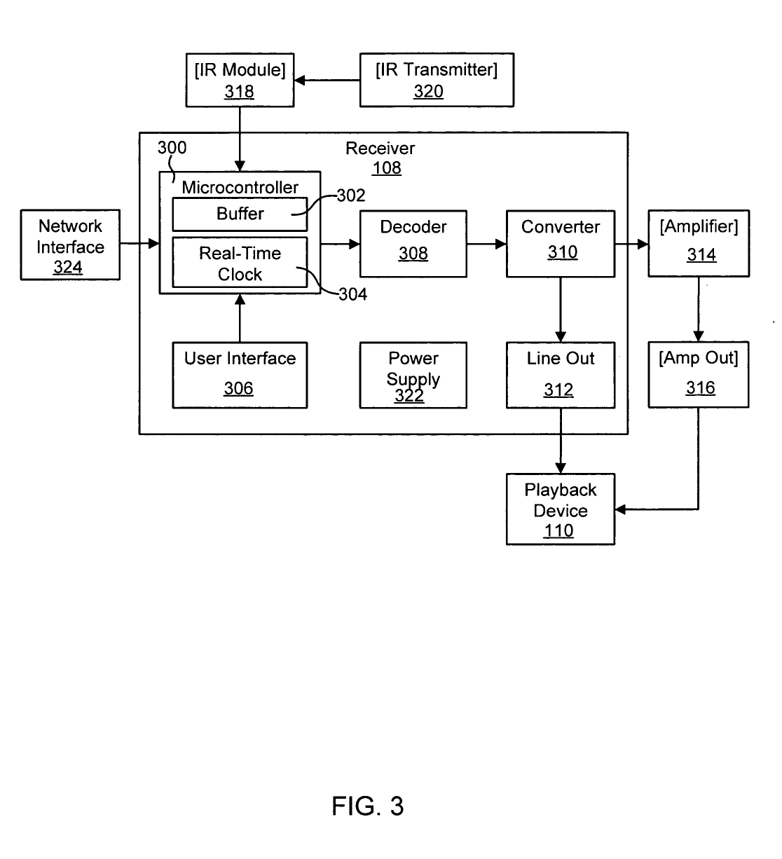

As discussed in more detail with reference to FIG. 3 below, a receiver 108 in accordance with the present invention may comprise, for example, a microcontroller component, a buffer module, a real-time clock, a decoder, a converter, and a line out. The receiver 108 may receive data transmitted over the network 204 and process the data to strip away any header information, order the data for playback, decode the data, convert the data to analog, and, in some embodiments, amplify the analog signal. In certain embodiments, the receiver 108 may also respond to local input by way of a user interface or IR module to control output volume, select specific data for playback, or perform other functions known to those in the art.

The receivers 108 may be operatively connected to a playback device 110 in each discrete playback location 102 to communicate playback data transmitted across the communication channel 106. A playback device 110 may comprise, for example, speakers, monitors, displays, or any other audio and/or visual playback device known to those in the art.

Referring now to FIG. 3, a receiver 108 in accordance with the present invention may comprise a microcontroller 300 capable of receiving data transmitted by the transmitter 104 over the asynchronous network 204 that is addressed to the receiver 108. A microcontroller 300 generally comprises a highly integrated chip which includes, for example, a central processing unit (“CPU”), random access memory (“RAM”), erasable programmable read only memory (“EPROM”), and input/output (“I/O”) functions.

Microcontroller 300 input may be regulated by an network interface module 324 comprising a transformer, an analog front end (“AFE”), a digital media access controller (“MAC”) data interface, and/or any other such device known to those in the art. A network interface module 324 may permit bidirectional data transmission such that data transmitted by the transmitter 104 to the receiver 108 may be processed by the microcontroller 300 while control codes, acknowledgement messages, or other information may be selectively transmitted from the microcontroller 300 back to the transmitter 104. A network interface module 324 in accordance with the present invention may operate in compliance with common communications standards, such as HomePlug™ or X10™. In one embodiment, the network interface module 324 comprises a conventional ethernet network interface card (NIC). The NIC may be connected to a HomePlug™ adapter (Not Shown) connected to a power line network 204. Alternatively, the HomePlug™ adapter or its functionality may be incorporated into the network interface module 324.

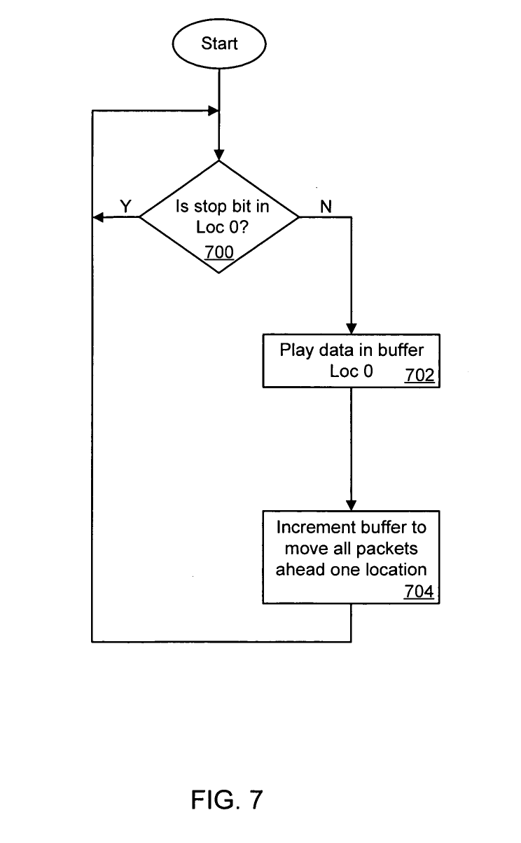

In certain embodiments, a microcontroller 300 may include a buffer 302 that acts as a temporary storage location for playback data transmitted to the receiver 108 by the transmitter 104. As discussed in more detail with reference to FIG. 7 below, the buffer 302 may comprise a first in first out (“FIFO”) buffer adapted to order a playback stream that includes several packets of playback data received by the receiver 108. The buffer 302 may thus function to allow the receiver 108 a window of opportunity for error detection and correction, including time to retrieve lost packets, adjust a playback data consumption rate, and perform other functions known to those in the art. Further, the buffer 302 may effectively prevent skips resulting from interference in the network 204, such as a communication channel that is selectively muted to accommodate a phone ringing, by enabling substantially continuous playback of data in the buffer 302 despite interference with incoming data.

The microcontroller 300, in certain embodiments, may further include a crystal controlled real time clock 304 that may be synchronized with a reference clock 206 in the transmitter 104. The microcontroller 300 may accept local control from a user interface 306 or infrared (“IR”) interface module 318 to synchronize the receivers 108, adjust playback volume, select certain data files 202 or playlists for playback, and/or perform other functions known to those in the art. The microcontroller 300 may further send data file 202 or playlist identification information through a user interface 306 or an IR interface module 318 to a personal digital assistant (“PDA”), remote control, or similar device.

A user interface 306 may comprise various push buttons, light emitting diodes (“LEDs”), a touch screen, or any other interface device known to those in the art capable of enabling direct user input. In certain embodiments, for example, a user interface 306 may comprise a mode select button that causes an LED to light by a corresponding function such as mute, volume, play list, treble, bass or program. As the mode button is repeatedly pushed, the next function is highlighted. When the desired function is indicated, additional buttons may enable a user to adjust operational parameters corresponding to the function. Alternatively, the user interface 306 may be implemented as a graphical user interface (“GUI”) presented to the user through a conventional computer system.

Similarly, an IR interface module 318 may enable direct input from a remotely located IR transmitter 320 to control basic functions such as output volume or mute functions. In some embodiments, an IR interface module 318 may integrate an IR transmitter 320 such that codes or information from the microcontroller 300 may be transmitted to a remote device, such as a remote control or a PDA, which may then display to a user a graphical interface corresponding to the receiver 108, or in certain embodiments, to the transmitter 104. A user may then use the PDA or remote control to view playback data identification information, edit play lists, adjust operational parameters, or perform other functions known to those in the art.

A microcontroller 300 in accordance with the present invention may further comprise an 12C bus to download data files 202 to a decoder 308 and to control internal registers of the decoder 308. A decoder 308 in accordance with certain embodiments of the present invention may support multiple sample rates and bit streams, and may comprise a single chip solution such as an STA013 or STA015 decoder chip or a software decoder implementation. In some embodiments, a decoder 308 may further comprise a bus for configuration and register control and may include internal volume, mute, treble and bass controls, as well as other controls known to those in the art.

A converter 310 in accordance with the present invention may comprise any device known to those in the art capable of converting one multimedia file format to another, such as a Cirrus Logic CS4334-KS digital to analog converter. In some embodiments, a converter 310 in accordance with the present invention may be capable of handling multiple conversion rates. A converter 310 may transmit playback data in an appropriate format, such as analog signals (audio and/or video), to a line out 312 for communication to a selected playback device 110. Alternatively, a converter 310 may first transmit playback data in an appropriate format to an amplifier 314 for signal amplification prior to playback through an amp out line 316.

Referring now to FIG. 4, an apparatus 400 for synchronized playback over an asynchronous network in accordance with the present invention may generally comprise an initialization module 402, a transmission module 404, a receiver module 412, and a playback module 422. An initialization module 402 may clear buffers of a buffer module 414 in the receiver module 412 prior to data transmission from the transmission module 404 to facilitate synchronized playback across receivers 412. The buffer module 414 may operate in a substantially similar manner to the buffer module 302 described in relation to FIG. 3. With the buffers cleared, new playback data may be buffered prior to playback. Next, playback may be initiated at substantially the same time. Provided the receivers 412 have substantially similar timing clocks, the receivers 412 may then playback the data from the buffers without significant latency typically caused by an asynchronous network such as the power line network 204.

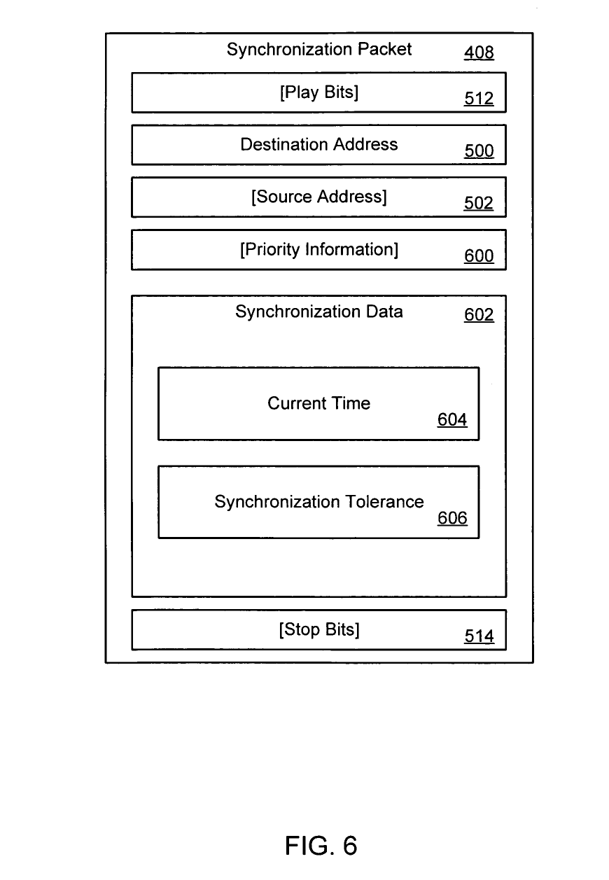

In certain embodiments, an initialization module 402 may synchronize real-time receiver clocks 304 (See FIG. 3) of a receiver module 412 with a reference clock 206 of a transmission module 404. An initialization module 402 may synchronize real-time clocks 206 and 304 by transmitting a synchronization packet 408 from the transmission module 404 to the receiver module 412, as discussed in more detail with reference to FIG. 6 below.

Additionally, an initialization module 402 may also initiate transmission of an initial start signal 424 from the transmission module 404 to the receiver module 412 to commence synchronized playback of playback data contained in buffers of the buffer module 414. An initial start signal 424 in accordance with the present invention is preferably individually addressed to each destination receiver module 412 to facilitate error detection and correction. If one receiver fails to acknowledge receipt of the start signal 424 to the transmitter 104, the transmitter 104 may reinitialize all receivers 108 until all receivers 108 successfully receive the start signal 424 at substantially the same time. Alternatively, an initial start signal 424 may be broadcast or multicast to receiver modules 412.

A transmission module 404 may transmit over an asynchronous network 204 playback data to at least two receiver modules 412. Playback data may comprise audio information, video information, other multimedia information, or a combination thereof. Playback data may comprise multiple playback data packets 406 having, in certain embodiments, a playback indicator 410 to facilitate maintaining synchronization between receivers 108 over time. A playback indicator 410 may comprise, for example, a playback bit 426 or a playback time stamp 428 included in a playback data packet 406. Typically, the playback indicator 410 includes a playback bit 426 or a playback time stamp 428. In selected embodiments, a playback indicator 410 may comprise a playback bit 426 used in conjunction with a playback time stamp 428.

A playback bit 426 may maintain synchronization between receiver modules 412 over time by advising receiver modules 412 to immediately initiate playback of the playback data packet 406 in which it is included. A playback bit 426 may be included with every playback data packet 406 transmitted over the asynchronous network 204, or with selected playback data packets 406. A playback bit 426 in accordance with the present invention may comprise, a single bit or multiple bits. For example, a play bit or a stop bit included in the header information of a playback data packet 406. In one embodiment, for example, a playback bit 426 corresponds to the first and last playback data packets 406 ordered for playback by a buffer module 414 such that re-synchronization may occur when playback of the buffered playback data concludes. In certain embodiments, as discussed in more detail below, the playback bit 426 may also be used to determine a playback data consumption rate. The receiver 108 may selectively adjust the playback data consumption rate to maintain synchronized playback in accordance with the present invention.

In some embodiments, a playback time stamp 428 may be included in a playback data packet 406 to initiate playback of a playback data packet 406 at a specific time indicated by the playback time stamp 428. Effective synchronization between receivers 108 utilizing a playback time stamp 428 as a playback indicator 410 depends on accurate synchronization between the receivers' 108 individual real-time clocks 304. Accordingly, certain embodiments of the present invention implementing a playback time stamp 428 to maintain synchronization across receivers 108 may also intermittently synchronize or re-synchronize the real-time clocks 304 of the receivers 108 using a synchronization packet 408 or other method of real-time clock re-synchronization. Although the synchronization packet 408 may be used in certain embodiments to facilitate synchronization, the synchronization packet 408 is not essential for the receivers 108 to playback the playback data synchronously.

A receiver module 412 in accordance with certain embodiments of the present invention may comprise a media control access device adapted to receive playback data packets 406, strip away header and control information from the packets 406, and forward a predetermined amount of playback data to a buffer module 414. As discussed in more detail with reference to FIG. 7 below, a buffer module 414 may function to order playback data according to preassigned sequence numbers and ensure continuous data playback.

In certain embodiments, a receiver module 412 may further comprise a determination module 416 for determining at each receiver 108 a playback data consumption rate based on the playback indicator 410, as mentioned above. Specifically, where a playback indicator 410 comprises a playback bit 426, a determination module 416 may determine whether the playback bit 426 corresponds to an expected location within a buffer of the buffer module 414. For example, where a playback bit 426 comprises a stop bit and a play bit and that the buffer has a front and a back. Newly received packets are added to the buffer from the back and pulled from the buffer for playback from the front. Packets in the buffer advance from back to front as packets are played.

The determination module 416 may determine a playback data consumption rate based on the size of the buffer, the number of packets between a packet having a stop bit set and a packet having a play bit set, and the number of expected packets between a start bit and a stop bit. Typically, the buffer includes only one packet with a play bit set and the packet at the front of the buffer has a stop bit set. If the number of packets between the packet with a playbit set and the packet with a stop bit set is equal to the expected number of packets between a stop bit and a play bit, the playback data consumption rate is what it is expected to be and the playback data consumption rate is equal to the expected playback consumption rate.

If the playback data consumption rate is greater than the expected playback consumption rate, the determination module 416 may delay the data consumption rate. If the playback data consumption rate is less than the expected playback consumption rate, the determination module 416 may accelerate the data consumption rate.

In embodiments of the present invention where the playback indicator 410 comprises a playback time stamp 428, a determination module 416 may compare the playback time stamp 428 with a current time of the real-time clock 304 of the receiver module 412. Where the playback time stamp 428 precedes the current time, a determination module 416 may accelerate a playback consumption rate to permit correlation between the playback time stamp 428 and the current time. Similarly, where the current time precedes the playback time stamp 428, a determination module 416 may delay a playback consumption rate to correlate the playback time stamp 428 with the current time.

A receiver module 412 in accordance with the present invention may further comprise a detection module 418 and a compensation module 420 to detect and compensate for a difference in playback consumption rates between two or more receiver modules 412. A detection module 418 may compute and identify playback latency outside of an acceptable synchronization tolerance by referencing a playback data consumption rate determined by the determination module 416. In some embodiments, a detection module 418 may detect data loss and may send a signal to the transmission module 404 to retransmit the lost data packet. Where lost data is not recovered after multiple retransmission attempts, a compensation module 420 may compensate for the latency by adjusting a playback consumption rate. One way to adjust the playback consumption rate is to insert pseudo data packets to replace missing playback data packets 406 and/or extend the number of packets to be played. In this manner, a receiver module 412 with a high consumption rate can be slowed to keep pace with the other receiver modules 412. Pseudo data packets may comprise, for example, a duplicate of a previously played playback data packet 406, predetermined data content, silence, and/or a predefined video frame that is blank, black, or of a particular color.

Finally, an apparatus 400 for synchronized playback over an asynchronous network in accordance with the present invention may comprise a playback module 422 adapted to play the playback data in response to a start signal 424 generated by the initialization module 402. A playback module 422 may comprise any playback device 110 (See FIG. 1) known to those in the art capable of communicating playback data to a user.

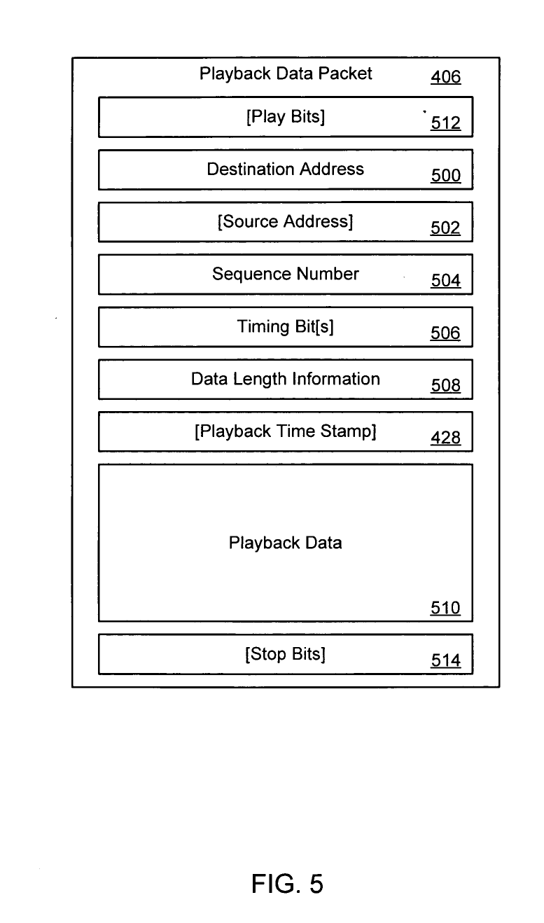

As previously discussed, certain data may be encapsulated into packets for transmission over an asynchronous network in accordance with the present invention. Referring now to FIGS. 5 and 6, selected embodiments of the present invention implement a playback data packet 406 and/or a synchronization packet 408 transmitted over an asynchronous network. Both a playback data packet 406 and a synchronization packet 408 generally comprise header information including a destination address 500 identifying the device intended to receive the packet and, in some embodiments, a source address 502. In certain embodiments, a playback data packet 406 may comprise a broadcast packet having a broadcast destination address 500. As all devices on a network accept and process broadcast packets, such a packet may be received substantially simultaneously by each device. Alternatively, a packet 406 may comprise a multicast packet having a multicast destination address 500. In this case, the packet 406 is received only by a subset of network devices specifically assigned to the multicast destination address 500.

Playback data packets 406 and synchronization packets 408 may further include a play bit 512 to indicate to the receiver module 412 that it should start playing the data, and a stop bit 514 to indicate that the receiver module 412 should stop playing the data. As discussed previously, either or both of a play bit 512 and stop bit 514 may act as a playback indicator 410 to maintain synchronicity across receiver modules 412. Alternatively, a playback time stamp 428 may be included in a playback data packet 406 to act as a playback indicator 410.

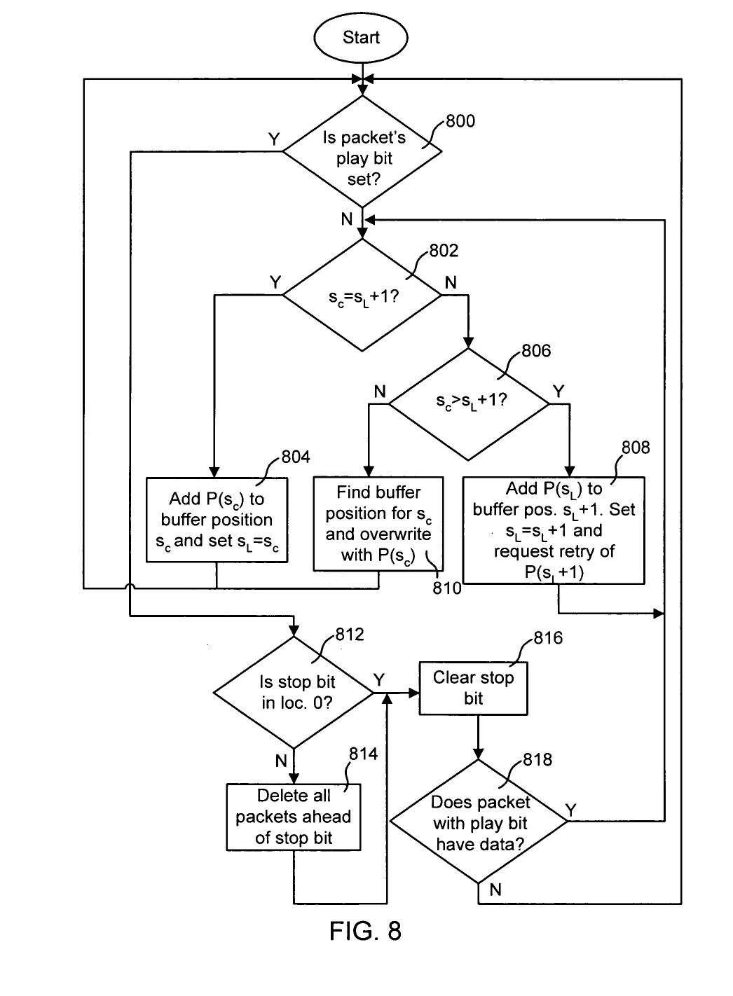

A playback data packet 406 may further comprise a sequence number 504 to indicate a playback order relative to other playback data packets 406. A buffer module 414 (See FIG. 4) may use the sequence number 504 to order playback data packets 406 as they are received, while a detection module 418 may reference a sequence number 504 for purposes of error detection and correction, as discussed in more detail with reference to FIG. 8 below. A compensation module 420 may reference a sequence number 504 for purposes of providing an appropriate pseudo data packet to replace a missed playback data packet 406.

In some embodiments, a playback data packet 406 may further comprise one or more timing bits 506 to define a frequency of coming data, and/or a data length indicator 508 to define a number of bits in the playback data packet 406. Finally, a playback data packet 406 may comprise playback data 510 including compressed or uncompressed digital audio, video and/or other multimedia signals. Playback data 510 may originate from a microphone, an amplifier or output from a musical instrument, audio/video output of another electronic device, or any other playback data source known to those in the art.

Referring now to FIG. 6, a synchronization packet 408 in accordance with the present invention may comprise priority information 600 indicating priority of the synchronization packet 408 relative to other packets distributed along the communication channel 106. Specifically, priority information 600 included in a synchronization packet 408 may comprise Quality of Service (“QoS”) information mandating that the synchronization packet 408 receive top priority in terms of transmission and processing priority relative to playback data packets 406. In this manner, the present invention may minimize latency in communicating synchronization information, thereby ensuring proper playback synchronization between receivers 108.

A synchronization packet 408 in accordance with the present invention may further comprise synchronization data 602 comprising, for example, a current time 604 and synchronization tolerance information 606. A synchronization packet 408 may thus be intermittently sent to receiver modules 412 to correlate a time of the real-time clock 304 of the receiver module 412 with a reference clock 206. A reference clock 206 may be integral to a transmission module 404 or transmitter 104, or may comprise an independent time server. Synchronization tolerance information 606 may enable a receiver module 412 to avoid interrupting and resetting its real-time clock 304 so long as the difference between the time of the real-time clock 304 and the current time 604 are within the specified synchronization tolerance 606.

In one embodiment of the present invention, a synchronization packet 408 is tied to a determination module 416 such that if the determination module 416 determines, based on a playback indicator 410, that a particular receiver module 412 is not properly synchronized, a transmission module 404 may automatically transmit the synchronization packet 408 to resynchronize the receiver modules 412. In other embodiments, a synchronization packet 408 may be transmitted periodically according to predetermined time intervals, intermittently at content-based intervals, such as between songs or during a scene transition, or according to user-initiated commands at the transmission module 404 and/or the receiver module 412.

The schematic flow chart diagrams that follow are generally set forth as logical flow chart diagrams. As such, the depicted order and labeled steps are indicative of one embodiment of the presented methods. Other steps and methods may be conceived that are equivalent in function, logic, or effect to one or more steps, or portions thereof, of the illustrated methods. Additionally, the format and symbols employed are provided to explain the logical steps of the methods and are understood not to limit the scope of the methods. The order in which a particular method occurs may or may not strictly adhere to the order of the corresponding steps shown.

Referring now to FIG. 7, a buffer module 414 in accordance with certain embodiments of the present invention may comprise a first-in-first-out (“FIFO”) buffer, where Location “0” of the buffer is the buffer output location and holds the playback data to be played next, Location “1” is the playback packet following the playback packet in Location “0”, and so on. Playback of buffered playback data packets 406 may thus proceed according to the following logic. First, a playback module 422 may determine 700 whether a stop bit 514 is in Location “0,” indicating that playback of the packet data has concluded. If yes, playback logic may loop to repeat the determination step 700 at a later time. If no, playback logic proceeds to initiate playback 702 of the data in buffer Location “0.” Following playback, the buffer module 414 may increment 704 playback data packets 406 to move all packets ahead one location, after which playback logic returns to the determination step 700.

Referring now to FIG. 8, a method in accordance with certain embodiments of the present invention may ensure properly sequenced playback as set forth below. As illustrated in FIG. 8, certain symbols have been designated to represent certain corresponding terms. Specifically, “P(s)” represents the packet with sequence number “s;” “s_{c}” represents the sequence number of the received packet, which has not yet been added to the buffer; and “s_{L}” represents the sequence number of the last packet received and added to the buffer.

When a receiver module 412 receives a packet, it must determine whether the packet includes a play bit 512. If yes, the method proceeds to determine 812 whether a stop bit 514 is set in the packet in Location “0.” If yes, the stop bit is cleared 816 and the method proceeds to determine 818 whether the packet with the play bit has data. If not, the method returns to the first determination step 800. Alternatively, if yes, the method proceeds to analyze 802 the received packet's sequence number 504 to determine whether the sequence number 504 is equal to one more than the last packet's sequence number. If the packet does not include a play bit 512 that is set in response to the first determination step 800, the method also proceeds to this analysis step 802.

If the received packet's sequence number 504 is equal to one more than the last packet's sequence number, the received packet is added 804 to the next location in the buffer, the sequence number of the received packet then becomes the last packet sequence number, and the method returns to the first determination step 800 and waits for the next packet. If the received packet's sequence number is not equal to one more than the last packet's sequence number, the method proceeds to determine 806 whether the received packet's sequence number is greater than one more than the last received packet. If yes, the last received packet may be duplicated and added 808 to the buffer at a position equal to one more than the last received packet's sequence number, and the duplicated packet's sequence number may be set equal to one more than the last packet's sequence number. Alternatively, a predetermined packet including silence and/or blank or colored video frames may be added to the buffer at a position equal to one more than the last received packet's sequence number. In this manner, the present invention identifies a missing packet, compensates for the missing packet, and maintains synchronization. In certain embodiments, the method may further request that the transmission module 404 resend the missing packet and then return to the analysis step 802.

Alternatively, if the received packet's sequence number is less than one more than the last packet's sequence number, the method finds 810 the buffer location for the received packet and overwrites that packet with the received packet. The method then returns to the first determination step 800.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for the synchronized playback of data transmitted over an asynchronous network, comprising:
an initialization module for initializing at least two receivers;
a transmission module for transmitting over an asynchronous network playback data to the at least two receivers;
a receiver module comprising a buffer module for buffering a predetermined amount of playback data at the at least two receivers; and
a playback module for playing the playback data in response to a start signal individually addressed to the at least two receivers.

2. The apparatus of claim 1, further comprising a determination module for determining at each of the at least two receivers a playback data consumption rate based on a playback indicator provided by the transmission module.

3. The apparatus of claim 2, wherein the playback indicator is selected from the group consisting of a playback bit and a playback time stamp.

4. The apparatus of claim 1, wherein the receiver module further comprises:
a detection module for detecting a difference in playback data consumption rates between the at least two receivers; and
a compensation module for compensating for the difference in playback data consumption rates between the at least two receivers.

5. The apparatus of claim 4, wherein the compensation module replaces missing playback data with pseudo data packets.

6. The apparatus of claim 4, wherein the compensation module adjusts the playback data consumption rate for at least one of the receivers.

7. The apparatus of claim 1, wherein the initialization module synchronizes real-time clocks corresponding to the at least two receivers with a reference clock.

8. The apparatus of claim 1, wherein the transmission module further transmits over the asynchronous network a synchronization data packet to maintain synchronization between the at least two receivers over time.

9. The apparatus of claim 8, wherein the transmission module intersperses the synchronization data packet between playback data packets transmitted over the asynchronous network.

10. The apparatus of claim 8, wherein the transmission module periodically transmits the synchronization data packet at predetermined time intervals.

11. A system for the synchronized playback of data transmitted over an asynchronous power line network, comprising:
a transmitter adapted to transmit playback data;
at least two receivers adapted to receive the playback data and to play the playback data in response to a start signal individually addressed to each of the at least two receivers;
a network operatively connecting the transmitter to the at least two receivers and adapted to carry the playback data; and
a playback device coupled to each receiver and configured to synchronously present the playback data to a user.

12. The system of claim 11, wherein each of the at least two receivers comprises a determination module for determining a playback data consumption rate based on a playback indicator provided by the transmitter.

13. The system of claim 12, wherein the playback indicator is selected from the group consisting of a playback bit and a playback time stamp.

14. The system of claim 11, wherein each of the at least two receivers further comprises a detection module to detect a difference in a playback data consumption rate between the transmitter and each of the at least two receivers.

15. The system of claim 14, wherein each of the at least two receivers further comprises a compensation module to accelerate the playback consumption rate of a receiver to compensate for the difference in playback data consumption rates between the at least two receivers.

16. A signal bearing medium tangibly embodying a program of machine-readable instructions executable by a digital processing apparatus to perform operations for the synchronized playback of data transmitted over an asynchronous network, the operations comprising:
an operation to initialize at least two receivers;
an operation to transmit playback data over an asynchronous network from a transmission module to the at least two receivers;
an operation to buffer a predetermined amount of playback data at the at least two receivers; and
an operation to play the playback data in response to a start signal individually addressed to each of the at least two receivers.

17. The signal bearing medium of claim 16, further comprising an operation to determine at each of the at least two receivers a playback data consumption rate based on a playback indicator provided by the transmission module.

18. The signal bearing medium of claim 17, wherein the playback indicator is selected from the group consisting of a playback bit and a playback time stamp.

19. The signal bearing medium of claim 16, further comprising:
an operation to detect a difference in a playback data consumption rate between the at least two receivers; and
an operation to compensate for the difference in the playback data consumption rates.

20. The signal bearing medium of claim 19, wherein the operation to compensate comprises replacing missing playback data packets with pseudo data packets.
